(19) United States
(12) Patent Application Publication
(10) Pub. No.: US 2008/0262968 A1
(43) Pub. Date: Oct. 23, 2008

(54) SOFTWARE LICENSING CONTROL VIA MOBILE DEVICES

(75) Inventors: Ashutosh Saxena, Ahmedabad (IN); Harigopal K. B. Ponnapalli, Hyderabad (IN)

Correspondence Address: KLARQUIST SPARKMAN, LLP, 121 SW SALMON STREET, SUITE 1600, PORTLAND, OR, 97204, US

(73) Assignee: Infosys Technologies Ltd., Bangalore (IN)

(21) Appl. No.: 12/055,290

(22) Filed: Mar. 25, 2008

(30) Foreign Application Priority Data
Mar. 26, 2007 (IN) 607/CHE/2007

(51) Int. Cl. G06Q 99/00; H04L 9/32

(52) U.S. Cl. 705/51

(57) ABSTRACT

Methods and systems to control a license for a software application are disclosed. The methods and systems can include requesting a central licensing server for initial verification and authentication of at least one user of a software application and sending a identification application from the central licensing server to at least one of the first device or the second device. A license identifier can be generated in the first device or the second device and sent to the central licensing server. The central licensing server can respond by sending a license key generator program to generate a dynamic key. The dynamic key can be input in the second device to execute the software application.

### BACKGROUND

A software license is an agreement that grants permission to utilize computer software. In various incarnations, software licensing comprises permissions, rights, and restrictions imposed on software by the copyright owner of the software. Use of software without a license could constitute infringement of the owner's intellectual property rights. Software license control grants and enforces a license for software, such as an application program, used in a workstation or in a personnel computer. Existing licensing models include: subscriptions, concurrent or floating licenses, rentals, and trial licenses such as try-before-you-buy or trial only. The traditional perpetual licensing model, however is still the most prevalent sales model used by software publishers today. Whatever the license model, it is important to ensure that there exists an anti-piracy solution for a publisher's software that operates in a cost effective manner.

Software licenses dictate the permissible uses of the corresponding software. Various strategies have been employed to make unauthorized duplication and use of software more difficult. One such approach is to provide a hardware dongle which is typically attached to a port of the computer to provide a software interlock. If the dongle is not in place, the software will not execute. Such a method is relatively expensive for the developer, and is also cumbersome for the authorized user, who must maintain possession of the dongle for the lifetime of the software application. Additionally, this solution is vulnerable to theft by duplication of the hardware dongle.

Another approach requires a user to enter a serial number or customer identification number during installation of the software. Missing or invalid registration information prevents installation of the software. This approach is commonly and easily defeated by transferring the serial number or customer identification number to unauthorized users.

Yet another approach requires registering the software with the manufacturer or distributor to obtain an operational code or password necessary for installation of the software. Once the operational code or password is obtained however, it may be perpetually transferred along with pirated copies to numerous unauthorized users.

Traditionally, the more expensive the software, the more likely the software publisher is to use a hardware-based solution. This is due to the higher level of security offered, as it relies on an external vendor controlled device, rather than the end user's computer. A software-based protection solution relies on the end user's computer to secure the digital license and maintain adherence to it. Typically, software-based solutions for perpetual licensing enforcement are less expensive than hardware-based solutions, and rely on a technology known as product activation.

Product activation refers to a method in which the customer types in a software product key or activation code purchased from the publisher to unlock the product for use based on the terms of the digital license. Once the activation code is entered by the customer, it is sent over a network, such as the Internet, or by phone call and verified with a server containing all valid codes shipped with the software. After the key is validated by the server, the application is unlocked and gives the customer access to the product. Because the customer has to enter data to activate; most software-based protection solutions require end-user interfaces. Some solutions provide the vendors with an added value of collecting valuable marketing user data through the activation process by integrating a user registration mechanism.

The license may include a limitation of time, so that the software is usable only for a period of time. A problem arises with many computer or client devices that are used to execute and run protected software because it is a simple task to reset the clock of a machine the software is executed on, or to set the clock back so as to extend the period of time the software may be used. This is possible because, in many forms, the license control mechanisms simply check the computer's clock when the software is installed and simply note the time from the machine's clock every time the software is executed. If a prescribed period of time has elapsed, according to the clock, the software quits and ceases execution. More sophisticated license enforcement schemes include keeping track of the total time the software is active, and disallowing any further execution once a cumulative time period has been reached.

Using a software-based protection solution for licensing oftentimes requires an end-user to activate his or her subscription via the Internet or phone, and sets the subscription end date on the server hosted by the publisher/service provider. The client software installed with the software protection solution communicates periodically with the server to ensure the subscription is still valid. Once the end-user nears his or her subscription end date, the end-user is reminded to renew and after a renewal is purchased, the subscription end date is updated appropriately on the server.

As discussed earlier, enforcing licensing via a dongle can be done in a couple of ways. In one, a standalone dongle is used in combination with a PC-based software clock to measure time. In another, a time dongle is used with a real-time secured clock on the dongle itself. The later solution is more expensive, but significantly enhances the level of security because utilizing the PC clock is more prone to hacking, allowing users to extend their subscription period without paying. Having an external clock that can only be communicated with through a secure encrypted protocol ensures that the clock is not tampered with, giving a much stronger level of license enforcement.

Because of the various limitations presented in traditional methods of license control, there is a need for an improved technique that reduces the above mentioned drawbacks that exist in the conventional methods.

### SUMMARY

Methods and systems to control a license for a software application are described herein. One particular implementation is described as follows. A device, such as a mobile device, is used to provide license keys to allow authorized usage of a protected software application executed on another device, such as a fixed device. In one implementation, a central licensing server is used for initial verification and authentication of at least one user of a software application and sending an identification application from the central licensing server to at least one of the first device or the second device. A license identifier can be generated in the first device or the second device and sent to the central licensing server to identify both the license certificate for the particular copy of the software application as well as the identity of the mobile device. The central licensing server can respond by generating and sending a license key generator program which generates a dynamic key when executed on the mobile device. The dynamic key can then be input in the fixed device to execute the software application.

In one implementation, a method of enforcing a usage agreement for a software application is described. The method comprises receiving a copy of the software application on a first device, the software application including license verification software which requests verification of a right of a user to use the software application before allowing the user to use the software application. The method also comprises submitting a license identification to a central licensing server and receiving, from the central licensing server, a license key generator program, which, when executed on the second device, provides a license key, which, when input into the license verification software on first device, allows usage of the software application by the user.

In another implementation, a system for providing licenses for a software application is described. The system comprises a license storage containing a plurality of license certificate and encryption key pairs, each assigned a unique license identifier, a license verification software module, configured to verify if a user currently has permission to use an installed copy of the software application, and a license key generator program generator module, configured to generate license key generator software for a first device upon receiving an identifier of the computer along with an identifier of a license and encryption key pair.

In another implementation, one or more computer-readable media are described which contain instructions, which, when executed on a first computer device, perform a method on the first device for authorizing a user to execute a software application on second device. The method comprises generating a license identifier, providing the license identifier to the second computer device, generating a dynamic license key in the first device using a license key generation application received from a central licensing server, and providing the dynamic license key to the second device to allow execution of the software application. Additionally, a new dynamic key is generated every time the license key generation application is executed in the first computer device.

In another implementation, a method of enforcing a usage agreement for a software application is described. The method comprises generating a license certificate and encryption key, storing the license certificate and encryption key as a pair, and generating a copy of a software application including license verification software which requests verification of a right of a user to use the software application before allowing the user to use the software application and a copy of the generated license certificate. The method also comprises receiving a copy of the software application on a fixed device, receiving a copy of an identifying application to a mobile device, and, after executing the identifying application on the mobile device, submitting a license identification comprising an identifier of the generated license certificate and a unique identifier for the mobile device to a central licensing server. The method also comprises generating a license key generator program at the central licensing server, the license key generator program configured to, when executed on the mobile device, provide a license key, which, when input into the license verification software on first device, allows usage of the software application by the user, receiving, from the central licensing server, the generated license key generator program, and inputting the license key into the software application to use the software application.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be made apparent from the following detailed description of embodiments that proceeds with reference to the accompanying drawings.

### BRIEF DESCRIPTION OF THE DRAWINGS

FIG. 1 is a flowchart illustrating an example process for enforcing a usage agreement for a software application.

FIG. 2 is a block diagram illustrating an example of a license control system according to techniques described herein.

FIG. 3 is a block diagram illustrating an example of production of software with licenses according to techniques described herein.

FIG. 4 is a flowchart illustrating an example process for producing software with associated licenses according to techniques described herein.

FIG. 5 is a flowchart illustrating an example process for using a software application with license control according to techniques described herein.

FIG. 6 is a flowchart illustrating an example process for granting a license.

FIG. 7 is a flowchart illustrating an example process for generating a license key generator program.

FIG. 8 is a flowchart illustrating an example process for verifying a license for a user.

FIG. 9 is a block diagram of a suitable computing environment for implementing techniques described herein.

### DETAILED DESCRIPTION

Described herein are techniques and systems for implementing license control using a computing device to validate license permissions for a user to use a software application. In one exemplary implementation, a license granting process installs a license key generator program on a mobile device. The mobile device is subsequently used to generate license keys which are input into a software application which is modified with license verification software to request a license key before allowing usage of the software.

Modifications and adaptations will be apparent to those skilled in the relevant arts in view of the following description in view of the accompanying drawings and the appended claims. While the systems and method described herein are provided with a certain degree of specificity, the present technique may be implemented with either greater or lesser specificity, depending on the needs of the user. Further, some of the features of the present technique may be used to advantage without the corresponding use of other features described in the following paragraphs. As such, the present description should be considered as merely illustrative of the principles of the present techniques and systems and not in limitation thereof.

### EXAMPLES OF ENFORCING A USAGE AGREEMENT

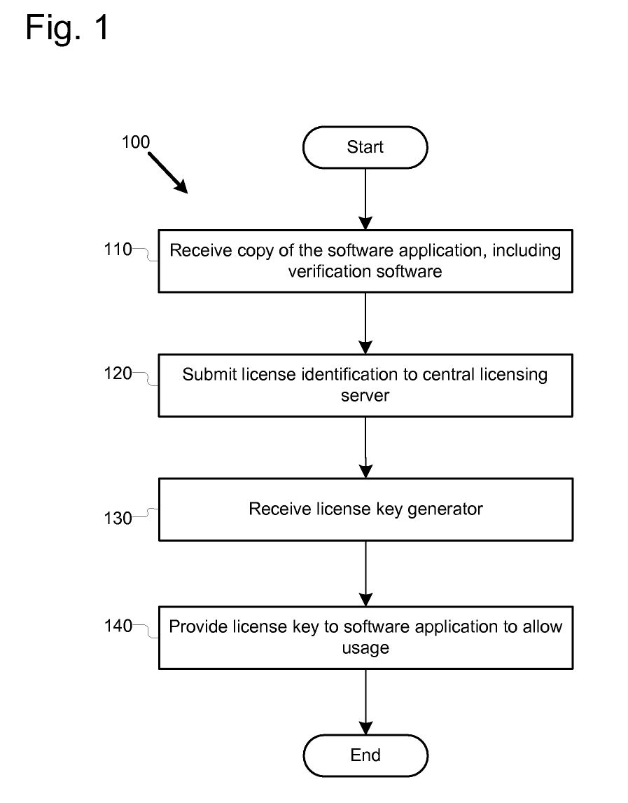

FIG. 1 is a flowchart illustrating an exemplary process for enforcing a user agreement according to the techniques described herein. In a typical implementation, most of the process of FIG. 1 is performed on a mobile device which is connected, or otherwise in communication with a fixed device upon which a protected software application is desired to be executed. The techniques described herein, including the process of FIG. 1, allow the mobile device to act as a generator of license keys, allowing the software to be used only by the person in control of the mobile device, thus increasing security while avoiding the need for expensive dedicated hardware dongles like in existing techniques.

FIG. 1 begins at block 110, where a copy of a protected software application is received. In one implementation the copy is received by a fixed computer device, such as a personal computer. However, in alternative implementations, the software application can be received by a mobile device which utilizes a connected fixed device to generate license keys.

FIG. 1 also illustrates that, in one implementation, the software application includes verification software. In some implementations, this verification software is added to an existing software application in order to allow licenses for that software application to be verified and usage permissions to be enforced. Processes for including verification software to protect applications are discussed below.

Next, the process continues to block 120, where a device, for instance a mobile device, submits a license identification to a central licensing server. As will be discussed below, this license identification serves, in one case, to identify a particular license or license certificate at the central licensing server with which the particular copy of the software application is associated. In alternative implementations, the license identification may also include other information such as a unique identifier for the mobile device. In various implementations, the license identification is in the form of an alpha-numeric key, such as, for example “Ab598cdefg2GI”.

Next, at block 130, the device, such as the mobile device, receives a license key generator program. This license key generator serves to generate license keys which are configured to specifically validate the previously-received copy of the software application. In effect, by executing the license key generator, the mobile device can act as a more robust license control technique than can a simple device such as a hardware dongle. As will be described below, in one implementation, the license key generator may also be configured to generate a different license key every time it is invoked. Finally, at block 140, the generated license key is provided to the protected software application in order that the user may use the application.

### EXAMPLES OF LICENSE CONTROL SYSTEMS

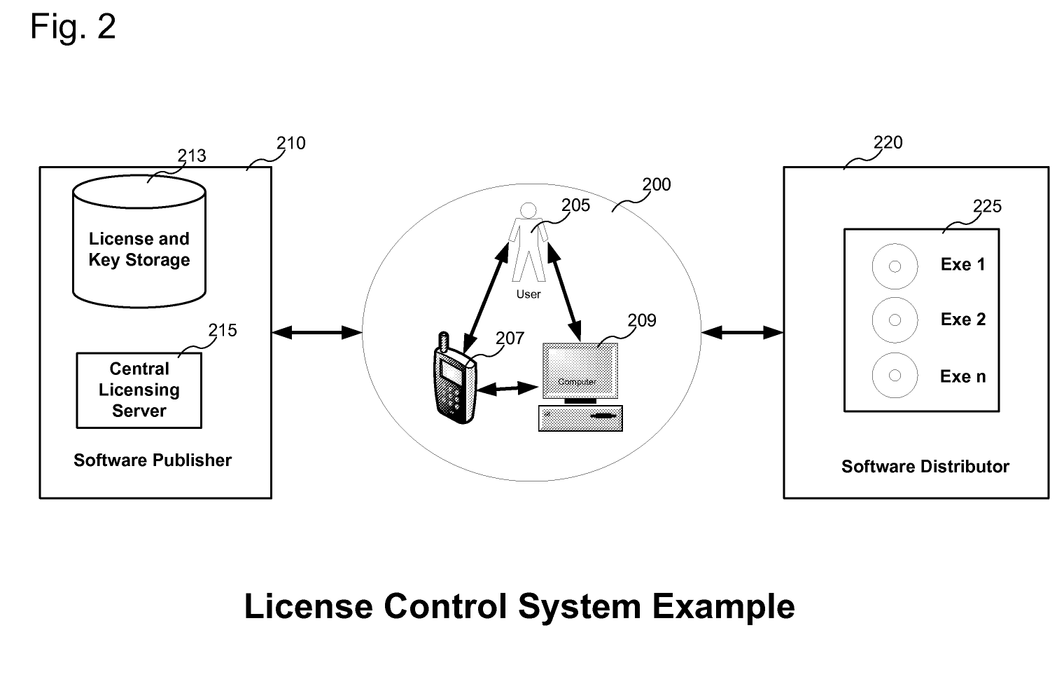

FIG. 2 is a block diagram illustrating various components of one implementation of a license control system according to the techniques described herein. In alternative implementations, the illustrated modules may or may not represent the entire set of implemented modules.

At a high level, the illustrated system represents communications between a software publisher 210, a user 205 and his or her associated devices 207 and 209 (represented as a whole by the grouping 200), and a software distributor 220.

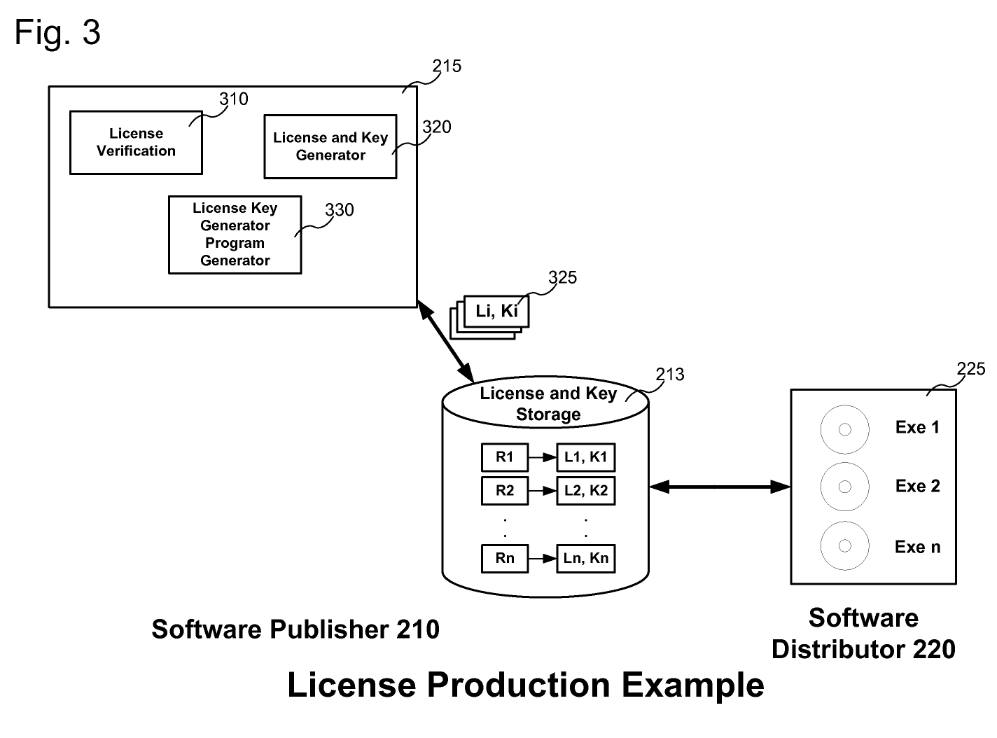

In an implementation the user grouping contracts to receive a copy of a software application from a software distributor 220, and is forwarded or given one of a set of protected executable files 225, each representing a copy of a desired software application. An exemplary method of producing the set of protected executable files 225 is described below with respect to FIG. 3.

The user grouping also interacts with a software publisher 210 to validate the user's permissions to use the software in accordance with the license between the software publisher and the user. As will be described below, this is done in one implementation using the central licensing server 215 and the license and key storage 213, both of which are maintained by the software publisher. In a typical implementation, the software publisher is the owner and/or creator of the software application, whereas the software distributor is an entity which sells or otherwise provides copies of the software application, such as a retail or online store.

In FIG. 2, the illustrated central licensing server 215 represents, in one implementation, a server connected to devices (such as the devices 207 and 209) through the Internet or through another computer network, a communication network or a combination thereof. While the user grouping 200 illustrates the software publisher 210 and the software distributor 220 communicating generally with the user grouping, in various implementations, communications between the various modules may occur directly with the devices 207 and 209 or by using the user 205 as an intermediary. Additionally, while the device 207 is illustrated as a mobile device, and the device 209 as a fixed device, in other implementations either device may be a mobile or fixed device or both devices may be the same type of device.

FIG. 3 is a block diagram illustrating modules and data flows between the software publisher 210 and the software distributor 220. The central licensing server 215 is illustrated with a license verification module 310, which serves to verify if a user currently has an unexpired license before granting a license. The illustrated central licensing server 215 also shows a license and key generator 320. This license and key generator 320 serves to create pairs of license certificates and encryption keys. Thus, FIG. 3 illustrates a plurality of license and encryption keys 325 (labeled Li and Ki). These keys are stored, in one implementation, in the software publisher's license and key storage 213. In the illustrated implementation, each license certificate and key pair is also paired with a license and key pair identifier. In one implementation, these identifiers are random values. In FIG. 3 the identifiers are represented by the various Ri in the license and key storage 213.

Finally, FIG. 3 illustrates a license key generator program generator 330 module in the central licensing server 215. This module serves, in one implementation, to generate license key generator programs. These programs are provided to a device (such as the mobile device 207) so that the mobile device can execute the program to generate license keys, allowing access to the protected software application.

Also illustrated in FIG. 3 is the software distributor 220. As illustrated in FIG. 3, the software distributor 220 maintains executable copies of the software application 225. In one implementation, each executable copy of the software application contains a copy of a license certificate. In another implementation, each copy is also associated with the license and key identifier Ri that is matched with its license certificate. The copy of the software application may comprise an installer which installs the application on a device after download, such as the fixed device 209. In one implementation, the installer provides an indication of the license and key identifier associated with that particular copy of the software application. This indication can be implemented as a second application, configured to run on either of the devices controlled by the user and which produces the associated indicator when run.

### EXAMPLES OF PROTECTED SOFTWARE APPLICATION PRODUCTION

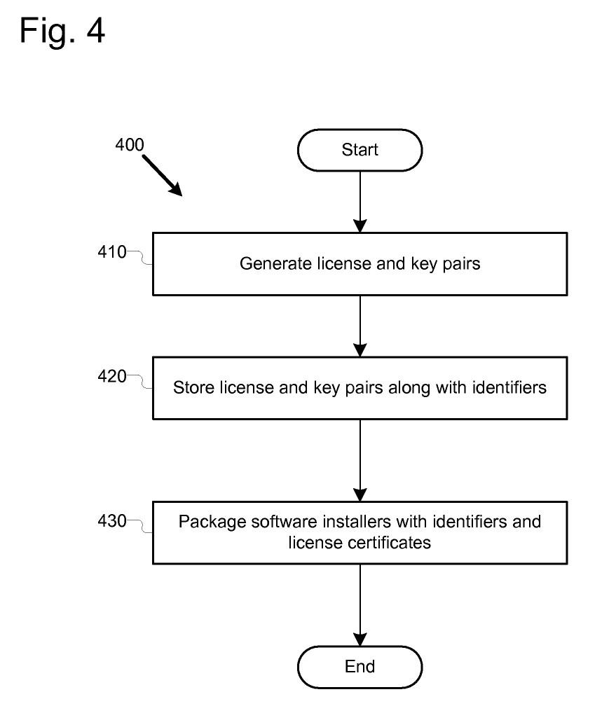

FIG. 4 is a flowchart illustrating an example process 400 for producing copies of the software application, such as those illustrated in FIG. 3. In various implementations, the various sub-process of FIG. 4 may be combined, or broken further into additional processes. The process begins at block 410, where the license and key generator module 320 generates a plurality of licenses certificate and key pairs. In various implementations, the license certificate can be a signer certificate or licensing criteria or combinations of both. It is these license certificates that are used during execution of the software application for verification of a user's rights. In one implementation, the license verification software embedded in the software application is responsible for verification of the license criteria against a user identity.

Next, at block 420, the central licenser server stores the license certificate and key pairs in the license and key storage along with identifiers for the pairs, as illustrated in FIG. 3. Finally, at block 430, copies of the software installers are packaged along with the identifiers and the license certificates, as discussed above. In one implementation this packaging may additionally comprise packaging the software application along with license verification software, if the application does not already have the ability to verify licenses on its own. In this manner, various applications that were not originally intended to be protected may be protected.

### EXAMPLES OF LICENSE CONTROL TECHNIQUES

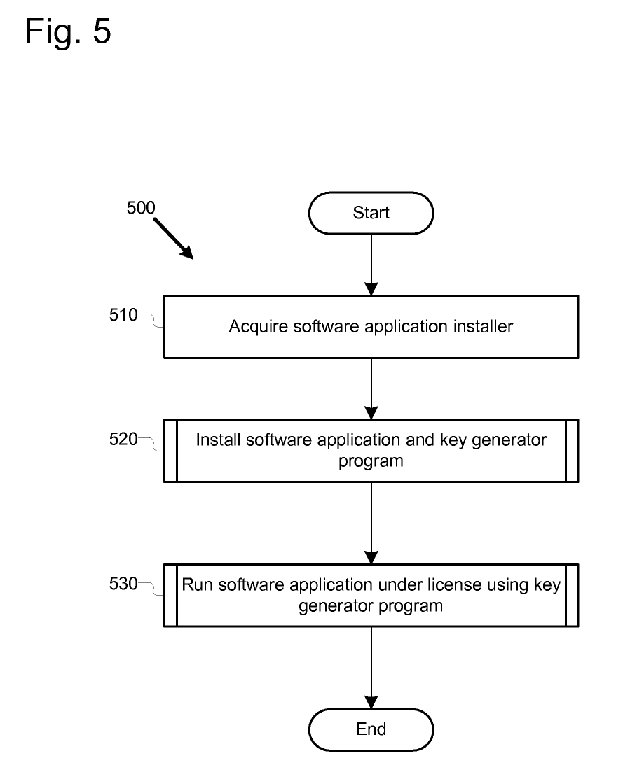

FIG. 5 is a flowchart illustrating an example process 500 for utilizing the software license control techniques described herein to grant and enforce a license for a software application. In various implementations, the various sub-process of FIG. 5 may be combined, or broken further into additional processes. The process begins at block 510, where the user acquires the software application installer. For example, the user may download and execute the installer on a fixed device, such as device 209. In another implementation, the installer may be executed on a mobile device, such as device 207. As in FIG. 4, the installer may be downloaded or otherwise acquired from the software distributor. In another implementation, instead of an application installer, the user may simply acquire an executable version of the application which does not need installation.

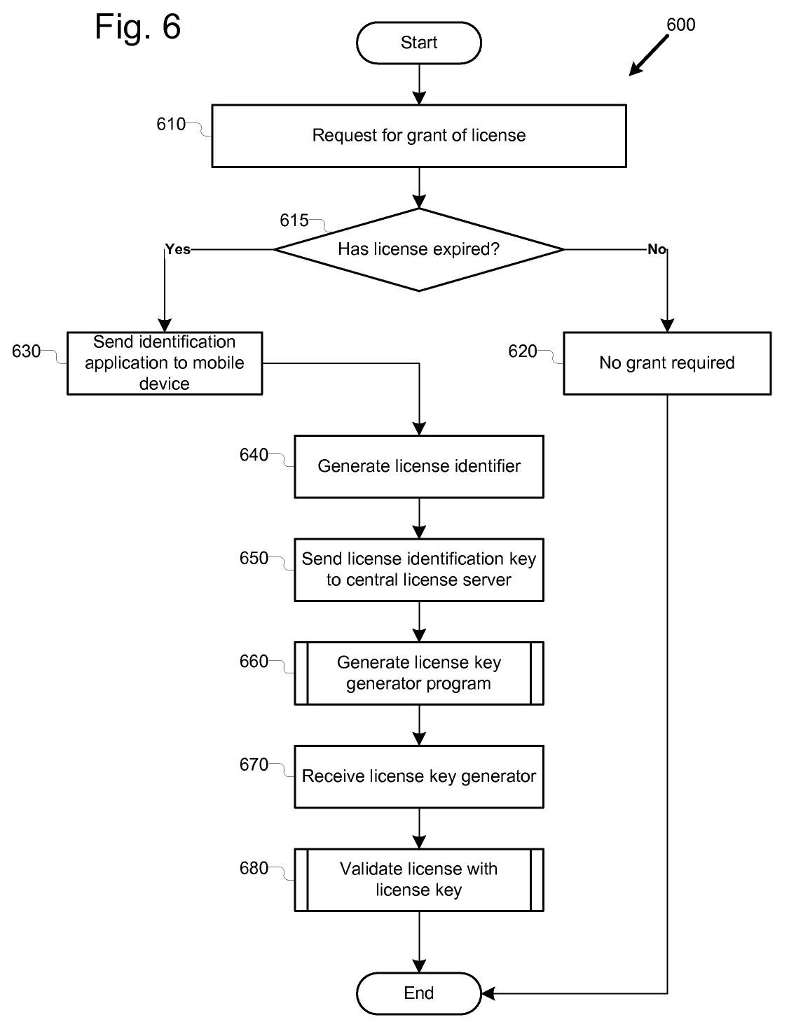

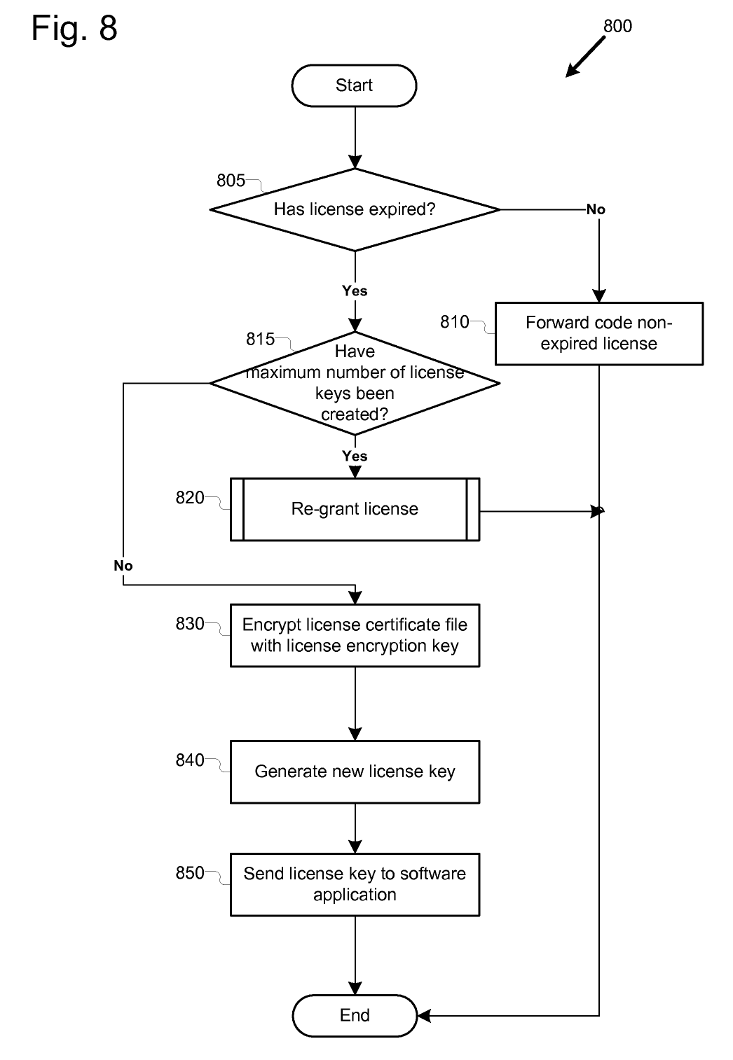

Next, at block, 520, the software application is installed along with the key generator program. An example of the process of block 520 is described below with respect to FIG. 6. Finally, at block 530, the software application is run under its license using the installed key generator program to validate the license. An example of the process of block 530 is described below with respect to FIG. 8.

FIG. 6 is a flowchart illustrating an example process 600 for installing the software and obtaining a license grant. In various implementations, the various sub-process of FIG. 6 may be combined, or broken further into additional processes. In one implementation, the process of FIG. 6 corresponds to the process of block 520 of FIG. 5. The process begins at block 610, where the device upon which the software application is being installed requests a grant of license. In one implementation, this is performed by consulting the central licensing server. Next, at decision block 615, the central licensing server determines if the license has expired. In one of the implementation, the user group shares a license identifier to the central licensing server along with a unique identifier of the mobile device, as will be discussed below. This is performed, in one implementation, by an application, as described below. In one implementation this is done only if software has previously been installed on the mobile device to send this information. Server validates the correctness of Ri and no further authentication is performed. In another implementation, license terms may be time bounded (e.g., applicable for a stipulated time period). So, if a grant of license for a software application is for an agreed-upon time period, this essentially means that the software application may be executed only if a current time reading is within the license period of the software application. If the time reading is beyond the time limit of license period, software licensing or access is not initiated or provided.

If the license has not expired, then no grant of license is required, for instance when the software application is being re-installed. In this case, the process continues to block 630, where no grant of license is required and the process ends.

If the current license has expired, or if no current license exists, then the process continues to block 630, where an identification application is sent. In the illustrated process, the application is sent to the mobile device, such as the mobile device 207. In alternative implementations, this identification application is sent to a fixed device. Next, at block 640, the identification application, upon being executed on either the mobile device 207 or the fixed device 209 generates a license identifier. While in one implementation this identifier may contain only the random license identifier stored in the license and key storage at the software publisher, in another implementation the generated identifier also comprises a unique identifier for the mobile device. For example if the mobile device is a mobile phone, the license identifier can comprise the International Mobile Equipment Identity or IMEI number for the mobile phone. In alternative implementations, other means of uniquely identifying the device on which the identification application is installed are used.

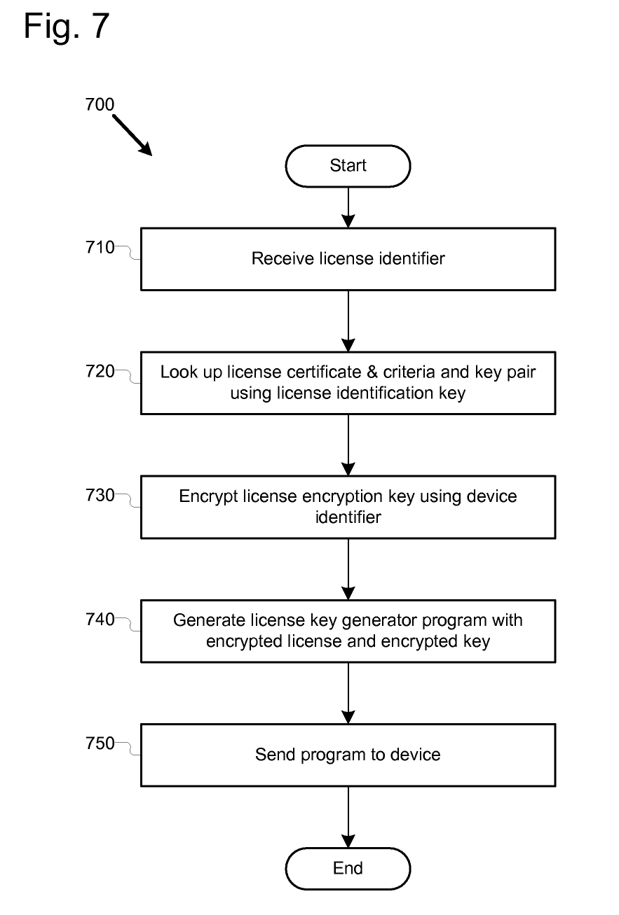

Next, at block 650 the license identifier is sent to the central licensing server. At block 660, the central licensing server generates a license key generator program is generated by the central licensing server based on the license identifier sent to it at block 650. An example of the process of block 660 is described below with respect to FIG. 7.

The process then continues at block 670, where the device which will generate license keys, such as the mobile device 207, receives the generated license key generator program. Next, at block 680, the license for the software application is validated using license keys generated by the key generator program.

FIG. 7 is a flowchart illustrating an example process 700 performed by the central licensing server for generating a license key generator program. In various implementations, the various sub-process of FIG. 7 may be combined, or broken further into additional processes. In one implementation, the process of FIG. 7 corresponds to the process of block 660 of FIG. 6.

The process of FIG. 7 begins at block 710, where the license and key identifier is received by the central licensing server. Next, at block 720, the central licensing server looks up the stored license certificate and key pair which is identified according to the license identification key contained in the license identifier. Next, at block 730 the license encryption key found in the key pair looked up at block 720 is encrypted using the unique device identifier received as part of the license identifier received at block 710. If an implementation is utilized where no identifier is sent to the central licensing server, then the license key may not be encrypted.

Next, at block 740, a license key generator program is generated by the central licensing server using an encrypted version of the license certificate and the encrypted encryption key. In one implementation the license certificate is encrypted with its associated encryption key that is stored with it in the license and key storage. Finally, at block 750, the generated program is sent to the device it is to be installed on.

FIG. 8 is a flowchart illustrating an example process 800 performed for validating a user's license using the device with the key generator program installed on it, such as a mobile device. In various implementations, the various sub-process of FIG. 8 may be combined, or broken further into additional processes. In one implementation, the process of FIG. 8 corresponds to the process of block 680 of FIG. 6. In another implementation, the process corresponds to the process of block 530 of FIG. 5.

The process begins at decision block 805, where one or both of the devices (e.g. the mobile device executing the key generator program and the fixed device executing the protected software application) determine if there is an expired license. This is done, in one implementation, similarly to the similar determination performed in the process of FIG. 6. If the license is found to not be expired, for example if the license granted the user is for a limited period of time but the time period has not yet ended, then at block 810, a non-expired license key is forwarded to the software application and the process ends. In one implementation, the user group 200 sends the same license identification information as was provided for first time, to request a renewed license.

Next, at decision block 815, the key generator program installed on the device determines if it has generated a maximum number of possible keys. This is due, in one implantation, to the fact that the key generator generates a new license key every time it is executed. By doing so, it prevents unauthorized usage of the protected software application. However, the key generator program may eventually run out of possible keys to generate. In this circumstance, the process continues to block 820, where the software license is re-granted, and in the process a new key generator program is created and installed on the device. In one implementation the process of block 820 is simply a repeat of the process of FIG. 5. In another implementation, the process of FIG. 5 is used without the process of determining if the license is expired, since this was already determined.

If, however, the key generator program has not exhausted its set of license keys, the process continues to block 830, where the license certificate contained in the key generator program is encrypted with the encryption key also contained in the program. As described above, in one implementation both the certificate and the encryption key are inserted into the key generator program during the process of FIG. 7. Next, at block 840 a new license key is generated using the encrypted license certificate generated at block 830. Then, at block 850, the license key is sent to the protected software application. In one implementation, this may be done directly, such as through a data cable or a wireless connection. In another, the system may request the user to input the license key himself or herself. At this point, the protected software application can verify the license key against its own internal license certificate and grant usage to the user.

Having described and illustrated the principles of the systems and methods described herein with reference to described implementations, it will be recognized that the described implementations can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

Exemplary Computing Environment

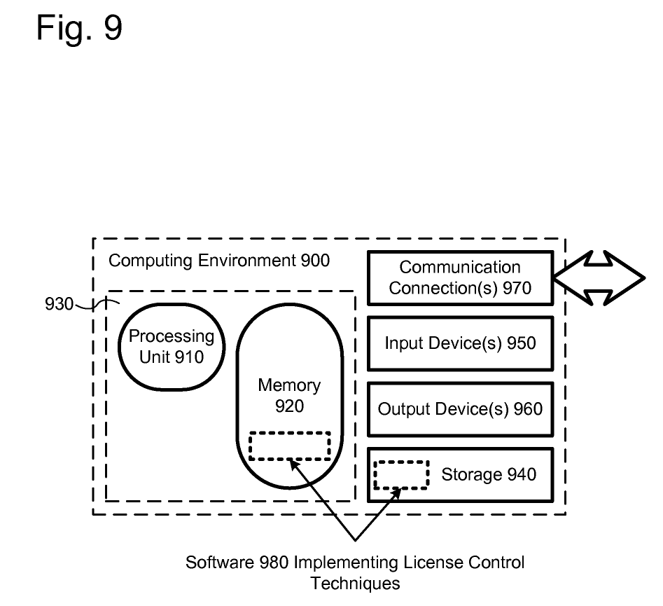

The above software licensing control techniques can be performed on any of a variety of computing devices. The techniques can be implemented in hardware circuitry, as well as in software executing within a computer or other computing environment, such as shown in FIG. 9.

FIG. 9 illustrates a generalized example of a suitable computing environment (900) in which described embodiments may be implemented. The computing environment (900) is not intended to suggest any limitation as to the scope of use or functionality of the invention, since the present invention may be implemented in diverse general-purpose or special-purpose computing environments.

With reference to FIG. 9, the computing environment (900) includes at least one processing unit (910) and memory (920). In FIG. 9, this most basic configuration (930) is included within a dashed line. The processing unit (910) executes computer-executable instructions and may be a real or a virtual processor. In a multiprocessing system, multiple processing units execute computer-executable instructions to increase processing power. The memory (920) may be volatile memory (e.g., registers, cache, RAM), non-volatile memory (e.g., ROM, EEPROM, flash memory, etc.), or some combination of the two. The memory (920) stores software (980) implementing the described techniques.

A computing environment may have additional features. For example, the computing environment (900) includes storage (940), one or more input devices (950), one or more output devices (960), and one or more communication connections (970). An interconnection mechanism (not shown) such as a bus, controller, or network, interconnects the components of the computing environment (900). Typically, operating system software (not shown) provides an operating environment for other software executing in the computing environment (900), and coordinates activities of the components of the computing environment (900).

The storage (940) may be removable or non-removable, and includes magnetic disks, USB drives, magnetic tapes or cassettes, CD-ROMs, CD-RWs, DVDs, BlueRay discs or combination thereof or any other medium which can be used to store information and which can be accessed within the computing environment (900). The storage (940) stores instructions for the software (980) implementing the described techniques.

The input device(s) (950) may be a touch input device such as a keyboard, mouse, pen, or trackball, a voice input device, a scanning device, or another device that provides input to the computing environment (900). For audio, the input device(s) (950) may be a sound card or similar device that accepts audio input in analog or digital form, or a CD-ROM reader that provides audio samples to the computing environment. The output device(s) (960) may be a display, printer, speaker, CD writer, or another device that provides output from the computing environment (900).

The communication connection(s) (970) enable communication over a communication medium to another computing entity. The communication medium conveys information such as computer-executable instructions, compressed audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The techniques described herein can be described in the general context of computer-readable media. Computer-readable media are any available media that can be accessed within a computing environment. By way of example, and not limitation, with the computing environment (900), computer-readable media include memory (920), storage (940), and combinations of any of the above.

The techniques herein can be described in the general context of computer-executable instructions, such as those included in program modules, being executed in a computing environment on a target real or virtual processor. Generally, program modules include routines, programs, libraries, objects, classes, components, data structures, etc., which perform particular tasks or implement particular abstract data types. The functionality of the program modules may be combined or split between program modules as desired in various embodiments. Computer-executable instructions for program modules may be executed within a local or distributed computing environment.

For the sake of presentation, the detailed description uses terms like “determine,” “generate,” and “compute” to describe computer operations in a computing environment. These terms are high-level abstractions for operations performed by a computer, and should not be confused with acts performed by a human being. The actual computer operations corresponding to these terms vary depending on implementation.

In view of the many possible variations of the subject matter described herein, we claim as our invention all such embodiments as may come within the scope and spirit of the following claims and equivalents thereto.

We claim:

1. A method of enforcing a usage agreement for a software application, the method comprising:
receiving a copy of the software application on a first device, the software application including license verification software which requests verification of a right of a user to use the software application before allowing the user to use the software application;
submitting a license identification to a central licensing server; and
receiving, from the central licensing server, a license key generator program, which, when executed on the second device, provides a license key, which, when input into the license verification software on first device, allows usage of the software application by the user.

2. The method of claim 1, wherein the second device is a mobile device.

3. The method of claim 2, wherein the first device is a fixed device.

4. The method of claim 1, wherein the received copy of the software application is associated with a license identifier and wherein the license identification submitted to the central licensing program includes the license identifier.

5. The method of claim 4, further comprising receiving, from the central licensing server, a license identification program, which, when executed, causes the device to generate the license identification and to submit the license identification to the central licensing server.

6. The method of claim 5, wherein the license identification program is received and executed on the second device.

7. The method of claim 5, wherein the license identification program is received and executed on the first device.

8. The method of claim 5, wherein the license identification also includes a unique identifier for the second device.

9. The method of claim 8, wherein the second device is a mobile telephone and the unique identifier for the second device comprises an International Mobile Equipment Identity number.

10. The method of claim 8, wherein the copy of the software application includes a license certificate file.

11. The method of claim 10, wherein license keys generated by the license code generator program include an encrypted version of the license certificate file encrypted with a license encryption key which is known by the copy of the software application.

12. The method of claim 11, wherein the license encryption key is received from the central licensing server along with the license key generator program.

13. The method of claim 12, wherein the license encryption key is itself encrypted using a key based at least in part on the unique identifier for the second device.

14. The method of claim 10, wherein the license certificate file comprises a signer certificate or license criteria or a combination thereof.

15. The method of claim 1, wherein the license key is manually input into the first device.

16. The method of claim 1, wherein the license key is electronically transmitted to the first device.

17. The method of claim 1, wherein the license key is provided to the central licensing server in addition to being provided to the first device.

18. The method of claim 1, further comprising, before downloading the license verification software verifying whether the user currently has permission to use the software application, and if the user currently has permission, allowing the user to use the software application without performing the other steps.

19. The method of claim 1, wherein each license key produced by the license key generator program is generated only once.

20. The method of claim 19, wherein, if the license key generator program cannot produce any more license keys, a new license key generator program is received from the central licensing server.

21. The method of claim 14, wherein the usage agreement for the software application includes at least one of a subscription agreement, a rental agreement, or a trial agreement.

22. A system for providing licenses for a software application, the system comprising:
a license storage containing a plurality of license certificate and encryption key pairs, each assigned a unique license identifier;
a license verification software module, configured to verify if a user currently has permission to use an installed copy of the software application; and
a license key generator program generator module, configured to generate license key generator software for a first device upon receiving an identifier of the computer along with an identifier of a license and encryption key pair.

23. The system of claim 22, further comprising a license certificate and encryption key generator, which is configured to generate license and encryption key pairs and to store these pairs in the license storage.

24. The system of claim 22, further comprising a software distribution module configured to distribute copies of the software application, each copy of the software application including a license certificate and a unique license identifier.

25. The system of claim 22, wherein the license verification software module is configured to send a license identification program to the first device, the license identification program configured to generate value comprising a unique license identifier as well as an identifier of the first device.

26. The system of claim 22, wherein the first device is a mobile device and the software application is used on a computer.

27. The system of claim 22, wherein license verification software module is configured to determine if a maximum period of time for the user to use the software has passed.

28. One or more computer-readable media containing instructions, which, when executed on a first computer device, perform a method on the first device for authorizing a user to execute a software application on second device, the method comprising:
generating a license identifier;
providing the license identifier to the second computer device;
generating a dynamic license key in the first device using a license key generation application received from a central licensing server; and
providing the dynamic license key to the second device to allow execution of the software application;
wherein, a new dynamic key is generated every time the license key generation application is executed in the first computer device.

29. A method of enforcing a usage agreement for a software application, the method comprising:
generating a license certificate and encryption key;
storing the license certificate and encryption key as a pair;
generating a copy of a software application including license verification software which requests verification of a right of a user to use the software application before allowing the user to use the software application and a copy of the generated license certificate;
receiving a copy of the software application on a fixed device;
receiving a copy of an identifying application to a mobile device;
after executing the identifying application on the mobile device, submitting a license identification comprising an identifier of the generated license certificate and a unique identifier for the mobile device to a central licensing server;
generating a license key generator program at the central licensing server, the license key generator program configured to, when executed on the mobile device, provide a license key, which, when input into the license verification software on first device, allows usage of the software application by the user
receiving, from the central licensing server, the generated license key generator program; and
inputting the license key into the software application to use the software application.
